(19) United States
(12) Patent Application Publication
(10) Pub. No.: US 2024/0425270 A1
(43) Pub. Date: Dec. 26, 2024

(54) AGITATION SYSTEM FOR LIQUID TRANSPORTING TANK ASSEMBLY

(71) Applicant: ALISAN LOJISTIK ANONIM SIRKETI, Istanbul (TR)

(72) Inventor: Muharrem Hilmi AKSOY, Konya (TR)

(21) Appl. No.: 18/274,067

(22) PCT Filed: Feb. 10, 2022
(86) PCT No.: PCT/TR2022/050112

§ 371 Date: Jul. 25, 2023

(30) Foreign Application Priority Data
Feb. 19, 2021 (TR) 2021/002358

(51) Int. Cl. B65D 88/74; B65D 88/12

(52) U.S. Cl. CPC B65D 88/748; B65D 88/128

(57) ABSTRACT

A rigid container (10) which is sealed properly and has a liquid transfer opening (14); a tank assembly consisting of rigid chassis (20) onto which container (10) is placed, characterized in that it consists of supporting element (32) provided between the chassis (20) and container (10) as well as a driving unit (40) that moves the container (10) positioned on the supporting element (32) in such a way that it is agitated on the chassis (20).

### TECHNICAL FIELD

The present invention relates to heating of tanks which are transporting liquids, especially heating of them by means of agitation process.

### STATE OF THE ART

The sealed containers are generally used for the transportation of hazardous and non-hazardous liquids. Containers are fixed onto a chassis and stored properly. The liquid substance in the container are generally heated by applying heat from the bottom part. Such heating method may require long time and high cost of energy.

GB2290522A publication describes a system related to heating of a tank system for the transportation of viscous material. A transportable container, preferably ISO type, is used for viscous material. The container has a rectangular base and covered and empty body defined by side walls projecting upwards from the end walls and bottom area. Side and end walls are connected with an upper wall. There are openings on the end wall such that heating arrangement is integrated inside the body to heat up the viscous material through one or more openings. A recess in the end wall provides a space for a connection valve through which the viscous material can be loaded/unloaded to/from the body. The upper wall contains an opening for the inspection and/or loading of viscous material.

### BRIEF DESCRIPTION OF INVENTION

The object of the invention is to heating up the liquid transporting tank systems by agitating in a short time and in a balanced manner.

In order to achieve the said object, the invention relates to a sealed rigid container that has liquid transfer opening; and a tank assembly containing a rigid chassis onto which the container is positioned. The tank assembly contains a supporting element provided between the chassis and the container as well as a driving unit that gives agitating action to the container-located on the supporting element-on the chassis when activated. It is also possible to heat up the liquid inside the tank assembly in a balanced manner as a result of the agitating action provided by the driving unit. During the heating of the liquid in the container, agitation process is applied for the stabilized heat transfer from the heated surface to the other parts. Due to the agitation process, the heated liquid reaches to other surfaces thereby raising the liquid temperature in a balanced manner. Due to the combination of the energy generated by agitation process with the heat energy, the time for heating up the liquid in the container is reduced. Reducing the amount of heat energy also provides cost advantage. It is both possible to agitate the tank assembly on a fixed base and also on a moving vehicle.

In a preferred embodiment of the invention, driving unit includes a hydraulic pump and a motor that imparts torque to the hydraulic pump. In this way, torque is imparted to the hydraulic pump by providing electricity to the motor thereby actuating the driving unit.

In a preferred embodiment of the invention, it contains a hydraulic piston actuated by the hydraulic pump and positioned at the bottom area of the chassis. As such, hydraulic fluid pressurized by the hydraulic pump is conveyed to the hydraulic piston and it enables the movement of hydraulic piston on a vertical axis.

In a preferred embodiment of the invention, an underframe is provided under the chassis to carry the container and chassis. It ensures the stabilization of the chassis and container. It also serves as housing for the hydraulic pump and motor.

In a preferred embodiment of the invention, the supporting element has a supporting shaft that carries container and chassis and stabilizes the hydraulic piston in a central point of the underframe. Thanks to supporting shaft, the weight of the container and chassis are carried together with the supporting points and it also ensures the vertical movement of the hydraulic piston in its own axis.

In a preferred embodiment of the invention, a corner-locking mechanism is provided to stabilize the container onto the chassis. This enables the prevention of overturning and skidding of container during the agitation process.

In a preferred embodiment of the invention, there is a controller to check the operation of driving unit. The controller enables the motor to operate in a pre-determined period and at a defined speed and also it stops the motor when the process is ended.

In a preferred embodiment of the invention, the controller is positioned in a controlling unit controlled by a user. In this way, the user may stop the driving unit in the event of any problem that may occur at the initial and termination phases or during the operation agitation process.

In a preferred embodiment of the invention, container and chassis are made of metallic material. It enables to form a durable and resistant structure during the agitation process. In an alternative embodiment, it can be made of alloy materials instead of metallic ones. In an other alternative embodiment, it can be made of reinforced carbon and plastic materials.

In order to achieve the said object, one embodiment of the invention includes the placement of the rigid and sealed container on the chassis; and control method for the tank assembly including the steps of stabilization of the container on the chassis with the corner-locking mechanism. The control method also includes the steps of actuating the driving unit in a pre-determined period by means of the controller positioned in the control unit and agitating the container by the driving unit which is in operation.

### BRIEF DESCRIPTION OF THE FIGURES

FIG. 1 shows the perspective view of tank assembly.

### DETAILED DESCRIPTION OF INVENTION

In this detailed description, the subject matter of the invention has been illustrated by way of non-exhaustive examples that only serve to better explain the subject.

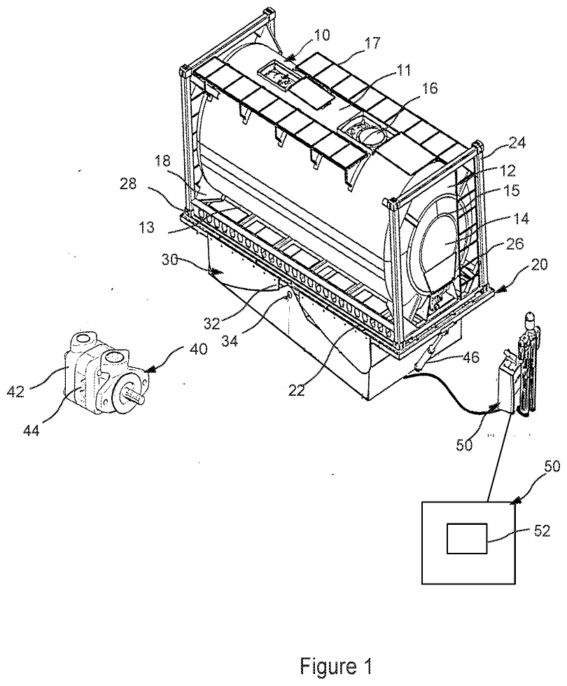

FIG. 1 shows the perspective view of the said tank assembly. The tank assembly is composed of a rigid container (10) which is made of metallic material with a proper liquid-proof characteristics. The container (10) has a liquid transfer opening (14) provided in its front wall (12). The liquid transfer opening (14) has a circular shape and it should be covered with a sealed lid (15) that fully covers on it. The lid (15) has similar diameters with the liquid transfer opening (14). The container (10) has an opening (16) in a close position to the front wall (12) located on the upper wall (11). Through the opening (16), it is possible to inspect the liquid inside the container (10). The upper wall (11) of the container (10) has two platforms (17) to enable the worker to walk on them. The worker on the platform (17) is able to monitor the liquid inside the container (10) through the opening (16). The container (10) is placed onto a rigid chassis (20) via its lower wall (13). The chassis (20) is made of metallic material due to its durable and resistant structure. The chassis (20) is composed of a base (22) and two lateral walls (24). There is a ladder (26) on each lateral wall (24) so as to enable the worker to climb up the platform (17) on the container (10). The container (10) is locked by a corner-locking mechanism (28) upon placing onto the chassis (20). The corner-locking mechanism (28) locks the extensions (18) at the lower part of the container (10). The base (22) of the chassis (20) consists of an underframe (30) to carry the chassis (20) and the container (10) on it. The underframe (30) is made of metallic material. The underframe (30) carries the chassis (20) from its supporting points so as to stabilize the weight of the system. In order the stabilize the weight, a supporting element (32) is used at the center point of the underframe (30). The supporting element (32) consists of a supporting shaft (34). The underframe (30) also accommodates a driving unit (40). The driving unit (40) gives momentum to the container (10) and the chassis (20), especially it initiates agitation process. The driving unit (40) consists of a hydraulic pump (44) and a motor (42) designed to impart torque to the hydraulic pump (44). The hydraulic fluid is pressurized by imparting torque to the hydraulic pump (44) from the motor (42) via electric power. The pressurized hydraulic liquid enables the hydraulic piston (46) provided on the base (22) of the chassis (20) to move. There is a controller (52) that controls the running of motor (42) and connected in such a way that it transmits the signal. The controller (52) enables the motor (42) to run or stop accordingly. The controller (52) is placed into the controlling unit (50) that is controlled by the user. The controlling unit (50) functions to start the agitation process, stop the agitation of tank assembly in case of emergency or stop it when the process is ended.

In order to start agitation process of the tank assembly, first of all, the rigid container (10) which is sealed properly is placed onto the chassis (20). The container (10) which is placed onto the chassis is locked onto the chassis (20) by means of the corner-locking mechanism (28). The Locking system prevents the container (10) from overturning or skidding during the agitation process. A command is sent to the controller (52) located inside the controlling unit (50) to run the motor (42) thereby starting the agitation process the locked container (10). The controller (52) runs the motor (42) in a pre-determined period and at the constant speed. The torque produced by running the motor (42) is imparted to the hydraulic pump (44). The hydraulic fluid is pressurized onto the hydraulic pump (44) and it ensures the actuation of hydraulic piston (46). Vertical movement of the hydraulic piston (46) provides the agitation process of the tank assembly. The supporting shaft keeps the hydraulic piston (46) at its vertical axis during the agitation process. Thanks to the performance of agitation process, the liquid in the container (10) is heated up with minimum energy in a short time. Due to the agitation process, the temperature of the heated surface of the liquid is mixed with the other surfaces thereby ensuring the balance between them. The temperature of the heated liquid is measured by a thermometer (not shown) placed outer surface of the container (10).

REFERENCE NUMBERS

| | |
|---|---|
| 10 | Container |
| 11 | Upper Wall |
| 12 | Front wall |
| 13 | Lower Wall |
| 14 | Liquid Transfer Opening |
| 15 | Cover |
| 16 | Opening |
| 17 | Platform |
| 18 | Extension |
| 20 | Chassis |
| 22 | Base |
| 24 | Lateral Wall |
| 26 | Ladder |
| 28 | Corner-Locking Mechanism |
| 30 | Underframe |
| 32 | Supporting Element |
| 34 | Supporting Shaft |
| 40 | Driving Unit |
| 42 | Motor |
| 44 | Hydraulic Pump |
| 46 | Hydraulic Piston |
| 50 | Control Unit |
| 52 | Controller |

1. A rigid container (10) which is sealed properly and has a liquid transfer opening (14); a tank assembly consisting of rigid chassis (20) onto which container (10) is placed, characterized in that it consists of supporting element (32) provided between the chassis (20) and container (10) as well as a driving unit (40) that moves the container (10) positioned on the supporting element (32) in such a way that it is agitated on the chassis (20).

2. A tank assembly according to claim 1, wherein the driving unit (40) consists of a hydraulic pump (44) and a motor (42) designed to impart torque to the hydraulic pump (44).

3. A tank assembly according to claim 2, wherein it consists of a hydraulic piston (46) actuated by the hydraulic pump (44) and positioned at the base part (22) of the chassis (20).

4. A tank assembly according to claim 1, wherein it consists of an underframe (30) provided so as to carry chassis (20) and container (10) at the base part (22) of the chassis (20).

5. A tank assembly according to claim 3, characterized in that supporting element (32) has a supporting shaft (34) that carries the container (10) and chassis (20) at a center point of the underframe (30) and that is adjusted to stabilize the movement of the hydraulic piston (46).

6. A tank assembly according to claim 1, wherein it consists of a corner-locking mechanism (28) that enables the container (10) to be stabilized on the chassis (20).

7. A tank assembly according to claim 1, wherein it consists of a controller (52) that controls the operation of the driving unit (40).

8. A tank assembly according to claim 7, characterized in that the controller (52) is positioned in the controlling unit (50) that can be controlled by the user.

9. A tank assembly according to claim 1 and characterized in that container (10) and chassis (20) are made of metallic material.

10. A control method for the tank assembly consisting of the steps of the placement of the rigid container (10), which is sealed properly, on the chassis (20) and stabilization of the container (10) on the chassis (20) by means of the corner-locking mechanism (28) wherein it consists of the steps of actuating the driving unit (40) by the controller (52) located in the control unit (50) and agitating the container (10) by the said driving unit (40).
